(19) United States
(12) Patent Application Publication
(10) Pub. No.: US 2026/0308068 A1
(43) Pub. Date: Oct. 8, 2026

(54) DIELECTRIC COMPOSITION WITH HIGH-TEMPERATURE STABILITY

(71) Applicant: AMOTECH CO., LTD., Incheon (KR)

(72) Inventors: Soomin OH, Incheon (KR); Haeyoung JIN, Incheon (KR); Junsuh YU, Incheon (KR); Kyuhwan PARK, Incheon (KR); Seongun MA, Incheon (KR); Tonggi KIM, Incheon (KR); Byoungchul RHO, Incheon (KR); Sumin YANG, Incheon (KR)

(73) Assignee: AMOTECH CO., LTD., Incheon (KR)

(21) Appl. No.: 19/483,133

(22) PCT Filed: May 10, 2024
(86) PCT No.: PCT/KR2024/006306

§ 371 Date: Dec. 1, 2025

(30) Foreign Application Priority Data
May 10, 2023 (KR) 10-2023-0060383

(51) Int. Cl. C04B 35/468; C04B 35/64

(52) U.S. Cl. CPC C04B 35/468; C04B 35/64; C04B 2235/3206; C04B 2235/3225; C04B 2235/3427

(57) ABSTRACT

A dielectric composition comprising a barium titanate-based base material major component and minor component is disclosed. The dielectric composition comprises: a first minor component which can be an oxide or carbonate of Yb; a second minor component which can be an oxide or carbonate of Dy and Y; a third minor component which can be an oxide containing Ba and Zr; a fourth minor component which can be an oxide or carbonate of Mg; a fifth minor component which can be an oxide or carbonate of V, Mn and Cr; and a sixth minor component which can be an oxide or carbonate of Si, wherein the at least one minor component can include the first minor component, the second minor component and the third minor component, and satisfies X7R characteristics specified in the EIA standard.

### TECHNICAL FIELD

The present disclosure relates to a dielectric composition with high-temperature stability, and in particular, to a dielectric composition that satisfies X7R characteristics.

### BACKGROUND ART

Multilayer ceramic chip capacitors have high capacitance and high reliability, but have a relatively small size, and therefore, are widely used in the fields requiring precision and stability such as automobiles and motors.

There are requirements for multilayer ceramic capacitors on various factors such as capacitance, temperature stability and voltage stability. Particularly, multilayer ceramic capacitors for electric fields used in automobiles operate under a high temperature, and therefore, the capacitance should not change even at a high temperature. In this regard, the Electronic Industries Association (EIA) of the United States provides that a multilayer ceramic capacitor satisfies X7R characteristics when a change in the capacitance at temperatures of −55° C. to 125° C. is around ±15% with respect to reference capacitance at 25° C.

### SUMMARY OF INVENTION

### Technical Problem

The present disclosure is directed to providing a dielectric composition that satisfies the X7R standard.

### Solution to Problem

A dielectric composition according to embodiments of the present disclosure includes a barium titanate-based base material major component and a minor component, wherein the minor component includes at least one minor component among a first minor component including one or more selected from the group consisting of oxides and carbonates of one or more elements among Yb, Sc, Lu and Tm; a second minor component including one or more selected from the group consisting of oxides and carbonates of one or more elements among Dy, Y, Ho, Tb, Gd, Eu and Er; a third minor component including one or more selected from the group consisting of oxides including Ba and Zr; a fourth minor component including one or more of oxides and carbonates of fixed-valence acceptor element including Mg; a fifth minor component including one or more selected from the group consisting of oxides and carbonates of variable-valence acceptor element including one or more of V, Mn, Cr, Fe, Ni, Co, Cu, and Zn; and a sixth minor component including one or more selected from the group consisting of oxides, carbonates and glass of Si element, the at least one minor component includes the first minor component, the second minor component and the third minor component, and a content of the one or more elements included in the first minor component is 0.2 parts by mole to 6 parts by mole with respect to 100 parts by mole of the base material major component, a content of the one or more elements included in the second minor component is 0.2 parts by mole to 6 parts by mole with respect to 100 parts by mole of the base material major component, and a content of the third minor component is 4 parts by mole to 6 parts by mole with respect to 100 parts by mole of the base material major component.

### Advantageous Effects of Invention

A dielectric composition of the present disclosure satisfies X7R characteristics of the EIA standard.

### BRIEF DESCRIPTION OF DRAWINGS

FIG. 1 is a perspective view illustrating a multilayer ceramic capacitor according to an embodiment of the present disclosure.

FIG. 2 is a see-through perspective view illustrating a plurality of electrode units of a multilayer ceramic capacitor according to an embodiment of the present disclosure.

### DESCRIPTION OF EMBODIMENTS

Hereinafter, the most preferred embodiments of the present disclosure will be described with reference to accompanying drawings in order to describe technical ideas of the present disclosure in detail to a degree that those skilled in the art may readily implement the technical ideas. First, it needs to be noted that, when adding reference numerals to constituents of each drawing, the same constituents are given the same numerals as possible even when they are shown in different drawings. In addition, when it is considered that, in describing the present disclosure, specific descriptions of known constitutions or functions related thereto may obscure the gist of the present disclosure, the detailed descriptions are not included.

The present disclosure relates to a dielectric composition, and an electronic component including the dielectric composition may include a capacitor, an inductor, a piezoelectric element, a varistor or a thermistor. Hereinafter, a multilayer ceramic capacitor (MLCC) will be described as an example of the dielectric composition and the electronic component.

### Multilayer Ceramic Capacitor

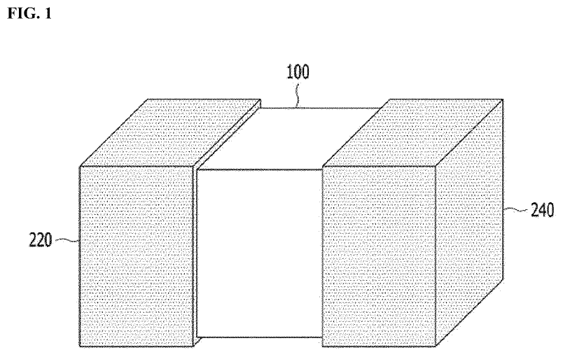

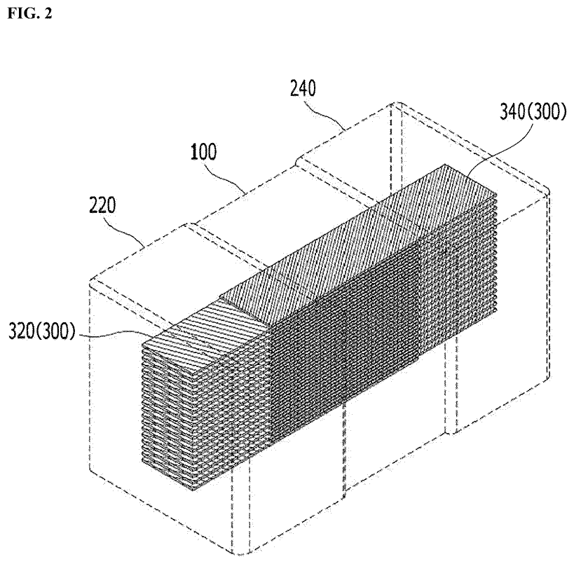

FIG. 1 is a perspective view illustrating a multilayer ceramic capacitor according to an embodiment of the present disclosure, and FIG. 2 is a see-through perspective view illustrating a plurality of electrode units of a multilayer ceramic capacitor according to an embodiment of the present disclosure.

Referring to FIG. 1, the multilayer ceramic capacitor according to an embodiment of the present disclosure is formed to include a dielectric 100, a first external electrode 220 and a second external electrode 240.

The dielectric 100 is formed as a rectangular parallelepiped having an upper surface, a lower surface, a first side surface, a second side surface opposite to the first side surface, a third side surface, and a fourth side surface opposite to the third side surface. As an example, the first side surface is the left side in the drawing, the second side surface is the right side in the drawing, the third side surface is the front surface in the drawing, and the fourth side surface is the rear surface in the drawing.

The dielectric 100 may include a plurality of dielectric sheets. The plurality of dielectric sheets may be stacked. Each of the dielectric sheets includes a dielectric composition, and may be formed by sintering the dielectric composition.

The first external electrode 220 is an electrode disposed on the first side surface of the dielectric 100. The first external electrode 220 may be formed to extend from the first side surface of the dielectric 100 to the upper surface, the lower surface, the third side surface and the fourth side surface of the dielectric 100. The second external electrode 240 is an electrode disposed on the second side surface of the dielectric 100. The second external electrode 240 may be formed to extend from the second side surface of the dielectric 100 to the upper surface, the lower surface, the third side surface and the fourth side surface of the dielectric 100. Such first external electrode 220 and second external electrode 240 may be formed to face each other while being separated at a predetermined interval from the upper surface, the lower surface, the third side surface and the fourth side surface of the dielectric 100.

Referring to FIG. 2, the stacked ceramic capacitor according to an embodiment of the present disclosure may further include a plurality of electrode units 300. Herein, the plurality of electrode units 300 may be stacked to form a laminate, and this laminate is disposed inside the dielectric 100.

The plurality of electrode units 300 are stacked in a vertical direction in the drawing to be disposed inside the dielectric 100. Each of the electrode units 300 includes a first electrode set 320 and a second electrode set 340, and the first electrode set 320 and the second electrode set 340 are alternately stacked to be formed.

The first electrode set 320 is formed as a plate-shaped conductor formed in a rectangular shape. The first electrode set 320 is disposed to lean toward the first side surface of the dielectric 100 inside the dielectric 100. A first end of the first electrode set 320 is connected to the first external electrode 220 on the first side surface of the dielectric 100.

The second electrode set 340 is formed as a plate-shaped conductor formed in a rectangular shape. The second electrode set 340 is disposed to lean toward the second side surface of the dielectric 100 inside the dielectric 100. A first end of the second electrode set 340 is connected to the second external electrode 240 on the second side surface of the dielectric 100.

The first electrode set 320 and the second electrode set 340 are each distributed and disposed on two adjacent dielectric sheets among the dielectric sheets included in the dielectric 100. The first electrode set 320 and the second electrode set 340 may be partially overlapped with the dielectric sheet in between.

### Dielectric Composition and Method for Preparing the Same

Hereinafter, a dielectric composition according to embodiments of the present disclosure and a method for preparing the same will be described in detail. The dielectric composition may form the dielectric 100 described above. However, in order to avoid redundant description, description overlapping the description provided above will not be included.

The dielectric composition according to embodiments of the present disclosure in may include a base material major component including rare-earth elements. The base material major component is a barium titanate-based compound including Ba and Ti, and may preferably be BaTiO₃. In addition, the dielectric composition according to embodiments of the present disclosure further includes a minor component, and the minor component may include a first minor component to a sixth minor component.

The dielectric composition according to embodiments of the present disclosure may include the minor components of Table 1 per 100 mol of the base material BaTiO₃.

TABLE 1

| First | | | Third | Fourth | | | | |
|---|---|---|---|---|---|---|---|---|
| Minor | Second Minor | | Minor | Minor | Fifth Minor | | | Sixth Minor |
| Component | Component | | Component | Component | Component | | | Component |
| Yb₂O₃ | Dy₂O₃ | Y₂O₃ | BaZrO₃ | MgCO₃ | V₂O₅ | MnO₂ | Cr₂O₃ | Ba_{0.6}Ca_{0.4}SiO₃ |
| 0.1-3.00 | 0.1-3.00 | 0-3.00 | 4.00-6.00 | 0.1-3.00 | 0.03-2.00 | 0.03-2.00 | 0.03-2.00 | 0.1-5.00 |

As a material of a dielectric of a multilayer ceramic capacitor for an alternating current circuit, compositions having COG characteristics have been mainly used. Compositions having COG characteristics use (CaSr)(TiZr)O₃, a low dielectric constant material, as a main material. Such compositions having COG characteristics have excellent electrostriction characteristics as paraelectrics, have a dissipation factor (DF) of 0.004, a sintering temperature of 1260° C. and very little temperature-dependent change in capacitance, but have low permittivity of about 30, making it difficult to achieve capacitance. Accordingly, when higher capacitance is required, a composition with a decreased Curie temperature by adding excessive amounts of BaZrO₃ and rare-earth ® structure at room temperature.

Thus, the composition in which BaZrO₃ and rare-earth materials (Gd₂O₃ and the like) are excessively added to BaTiO₃ has permittivity of 800, a dissipation factor (DF) of 0.02 and a sintering temperature of 1200° C., having relatively higher permittivity compared to existing compositions having COG characteristics, and excellent electrostriction characteristics. However, the composition has significantly low permittivity compared to general compositions having X7R characteristics, and it is still difficult to achieve high capacitance.

In order to address this issue, the dielectric composition according to embodiments of the present disclosure has first to third minor components to be described later added to BaTiO₃, thereby providing a dielectric composition suitable for an alternating current since it satisfies the X7R standard that requires a change in the range of 15% to −15% and has high permittivity compared to existing compositions having COG characteristics and compositions in which BaZrO₃ and rare-earth materials (Gd₂O₃ and the like) are excessively added to BaTiO₃, and low dissipation factor of less than 0.01. The dielectric composition according to embodiments of the present disclosure has relatively high permittivity, which is advantageous for achieving capacitance, and has excellent electrostriction characteristics and low dissipation factor compared to existing compositions having X7R characteristics, and is thereby suitable for an alternating current circuit.

Hereinafter, each component of the dielectric composition according to embodiments of the present disclosure will be described more specifically.

### Base Material Major Component

The dielectric composition according to embodiments of the present disclosure may include a base material major component including Ba and Ti. According to embodiments, the base material major component is BaTiO₃.

The base material major component may be included in the dielectric composition in a powder form. An average particle diameter of the base material major component powder is not particularly limited, but may be 1000 nm or less. Preferably, an average particle diameter of the base material major component powder may be 200 nm to 350 nm, and more preferably 250 nm.

### First Minor Component

The dielectric composition according to embodiments of the present disclosure may include one or more selected from the group consisting of oxides and carbonates of one or more elements among Yb, Sc, Lu and Tm as the first minor component. The first minor component is preferably one or more selected from the group consisting of oxides and carbonates of Yb element, but is not limited thereto. Alternatively, the first minor component may also include one or more selected from the group consisting of oxides and carbonates of one or more elements among Sc, Lu and Tm, which are other rare-earth elements, instead of the Yb element.

The first minor component may be included in an amount of 0.2 parts by mole to 6 parts by mole or less with respect to 100 parts by mole of the base material major component. The content of the first minor component may be based on the content of the one or more elements included in the first minor component regardless of the form of addition such as an oxide or a carbonate. For example, the total content of the elements included in the first minor component may be 0.2 parts by mole to 6 parts by mole with respect to 100 parts by mole of the base material major component. As an example, assuming that the first minor component is Yb₂O₃ and the Yb₂O₃ is present in an amount of 2 parts by mole with respect to 100 parts by mole of BaTiO₃, Yb, the metal included in the first minor component, is present in an amount of 4 parts by mole. Accordingly, in this case, Yb is included in an amount of 4 parts by mole with respect to 100 parts by mole of BaTiO₃.

The first minor component may be effective in shifting the Curie temperature toward a higher temperature and improving stability of capacitance depending on the change in temperature. In other words, the first minor component performs a role of preventing a decrease in reliability of a multilayer ceramic capacitor formed with the dielectric composition according to embodiments of the present disclosure.

When the content of the Yb element included in the first minor component is less than 0.2 parts by mole with respect to 100 parts by mole of the base material major component, the effect of improving high temperature TCC (temperature coefficient of capacitance) may not be significant, and when the content of the Yb element included in the first minor component is greater than 6 parts by mole with respect to 100 parts by mole of the base material major component, properties relating to calcination may deteriorate.

### Second Minor Component

The dielectric composition according to embodiments of the present disclosure may include one or more selected from the group consisting of oxides and carbonates of one or more elements among Dy, Y, Ho, Tb, Gd, Eu and Er as the second minor component. The second minor component may be one or more selected from the group consisting of Dy₂O₃ and Y₂O₃, and herein, the total content of Dy₂O₃ and Y₂O₃ may be 0.2 parts by mole to 6 parts by mole. Alternatively, the second minor component may also include one or more selected from the group consisting of oxides and carbonates of one or more elements among Ho, Tb, Gd, Eu and Er, which are other rare-earth elements, instead of Dy and Y.

The second minor component may be included in an amount of 0.2 parts by mole to 6 parts by mole or less with respect to 100 parts by mole of the base material major component. The content of the second minor component may be based on the content of the one or more elements included in the second minor component regardless of the form of addition such as an oxide or a carbonate. For example, the total content of the elements included in the second minor component may be 0.2 parts by mole to 6 parts by mole with respect to 100 parts by mole of the base material major component. As an example, assuming that the second minor component includes Dy₂O₃ and Y₂O₃ and the Dy₂O₃ is present in an amount of 1 part by mole and the Y₂O₃ is present in an amount of 0.5 parts by mole with respect to 100 parts by mole of BaTiO₃, Dy and Y, which are the metals included in the second minor component, are present in amounts of 2 parts by mole and 1 part by mole, respectively. Accordingly, in this case, the total content of the elements included in the second minor component is 3 parts by mole with respect to 100 parts by mole of BaTiO₃.

The second minor component may perform roles of helping with improvement in high temperature TCC, and preventing a decrease in reliability of a multilayer ceramic capacitor formed with the dielectric composition. When the content of the elements included in the second minor component is less than 0.2 parts by mole or greater than 6 parts by mole with respect to 100 parts by mole of the base material major component, such effects may be insufficient.

### Third Minor Component

The dielectric composition according to embodiments of the present disclosure may include one or more selected from the group consisting of oxides including Ba and Zr as the third minor component. The third minor component is preferably BaZrO₃ or a mixture of BaO and ZrO₂, but is not limited thereto. In the case of BaZrO₃, the ratio between Ba and Zr is not particularly limited, and the molar ratio of Ba to Zr (Ba/Zr) may be 0.5 to 1.5 and preferably 0.9 to 1.1.

When the third minor component is added, overall permittivity may decrease, and temperature-dependent change in permittivity may be smoothened. The third minor component may be included in an amount of 4 parts by mole to 6 parts by mole or less with respect to 100 parts by mole of the base material major component. When the content of the third minor component is less than 4 parts by mole with respect to 100 parts by mole of the base material major component, the effect of improving high temperature TCC may not be significant, and when the content of the third minor component is greater than 6 parts by mole with respect to 100 parts by mole of the base material major component, high temperature withstand voltage characteristics may deteriorate.

### Fourth Minor Component

The dielectric composition according to embodiments of the present disclosure may include one or more of oxides and carbonates of fixed-valence acceptor element including Mg as the fourth minor component.

The fourth minor component may be included in an amount of 0.1 parts by mole to 3 parts by mole or less with respect to 100 parts by mole of the base material major component. The content of the fourth minor component may be based on the content of the Mg element included in the fourth minor component regardless of the form of addition such as an oxide or a carbonate. For example, the content of the Mg element included in the fourth minor component may be 0.1 parts by mole to 3 parts by mole or less with respect to 100 parts by mole of the base material major component.

The content of the fourth minor component being less than 0.1 parts by mole or greater than 3 parts by mole with respect to 100 parts by mole of the dielectric base material major component is not preferred since there may be a problem in that the permittivity decreases and the high temperature withstand voltage characteristics deteriorate.

### Fifth Minor Component

The dielectric composition according to embodiments of the present disclosure may include one or more selected from the group consisting of oxides and carbonates of variable-valence acceptor element including one or more of V, Mn, Cr, Fe, Ni, Co, Cu, and Zn as the fifth minor component. The fifth minor component is preferably one or more selected from the group consisting of V₂O₅, MnO₂ and Cr₂O₃, but is not limited thereto.

The fifth minor component may be included in an amount of 0.03 parts by mole to 4 parts by mole or less with respect to 100 parts by mole of the base material major component. The content of the fifth minor component may be based on the content of the elements included in the fifth minor component regardless of the form of addition such as an oxide or a carbonate. For example, the total content of the elements included in the fifth minor component may be 0.03 parts by mole to 4 parts by mole with respect to 100 parts by mole of the base material major component.

The fifth minor component is capable of improving high temperature withstand voltage characteristics by improving reduction resistance of the dielectric composition. When the content of the fifth minor component is less than 0.03 parts by mole, the high temperature withstand voltage may decrease, and when the content is greater than 4 parts by mole, reliability of the dielectric composition may be reduced (for example, decrease in permittivity and the like).

### Sixth Minor Component

The dielectric composition according to embodiments of the present disclosure may include one or more selected from the group consisting of oxides of Si element, carbonates of Si element and glass including Si element as the sixth minor component. Preferably, the sixth minor component may include a composite oxide represented by BaₓCa₁₋ₓSiO₃ (herein, x is 0.3 to 0.8). The x value of the composite oxide may be 0.3 to 0.8. Herein, when the x value is too small, dielectric properties may deteriorate due to the reaction between SiO₂ and BaTiO₃ that is the main component. When the x value is too large on the contrary, the melting point may increase, degrading properties relating to calcination.

The sixth minor component may be included in an amount of 0.1 parts by mole to 5 parts by mole or less with respect to 100 parts by mole of the base material major component. When the content of the sixth minor component is less than 0.1 parts by mole, the rate of temperature-dependent change in capacitance may increase. On the contrary, the content of the sixth minor component being greater than 5 parts by mole is not preferred since there may be a problem of reduced sinterability and density, the formation of a secondary phase, and the like.

### Experimental Example

A BaTiO₃ mixed solid solution powder, which is a base material powder including a major component, was prepared using a solid phase method as follows.

Starting raw materials are BaCO₃ and TiO₂. These starting raw material powders were mixed using a ball mill and calcined in a range of 900° C. to 1000° C. to prepare a major component base material powder. After mixing a minor component additive powder into the major component base material powder in the composition ratio shown in Table 2, the raw material powder including the major component and the minor component was ball milled for a predetermined time (for example, 20 hours) by using a zirconia ball as a mixing/dispersing medium and mixing ethanol/toluene, a dispersant and a binder.

The prepared slurry was prepared into a molded sheet having a thickness of 10 μm using a doctor blade-type coater, and a Ni internal electrode was printed on this molded sheet. Upper and lower covers were prepared by stacking a covering sheet to 25 layers, and 21 layers of the printed active sheets were stacked by pressurizing to prepare a press bar. The press bar was cut into chips having a size of 3225 (length×width×thickness of 3.2 mm×2.5 mm×2.5 mm) using a cutter.

The prepared chip was plasticized, then calcined for 1 hour or longer at a temperature of 1210° C. to 1320° C. under a reduced atmosphere (0.1% H₂/99.9% N₂, H₂O/H₂/N₂ atmosphere), and then heat treated by conducting reoxidation for 2 hours or longer at 1000° C. under a nitrogen (N₂) atmosphere.

The calcined chip underwent termination process and electrode calcination using a copper paste to complete an external electrode.

For the multilayer ceramic capacitor specimen completed as above, capacitance (permittivity), sintering temperature and dissipation factor (DF), temperature-dependent change in capacitance (TCC) and the like were measured and evaluated. In addition, room temperature insulation resistance, high temperature accelerated lifetime and the like were evaluated, which, however, are not described.

As for room temperature capacitance, capacitance was measured under a condition of 1 kHz and AC 0.2 V/μm using an LCR-meter. From the capacitance, the dielectric thickness of the multilayer ceramic capacitor (MLCC) chip, the internal electrode area and the number of stackings, permittivity of the multilayer ceramic capacitor (MLCC) chip was calculated.

The dissipation factor (DF) was measured at 1 KHz and 1 Vrms using a capacitance meter (Keysight, E4981A).

The temperature-dependent change in capacitance was measured in a temperature range of −55° C. to 125° C. In the corresponding temperature range, the change in capacitance was measured under a condition of 1 kHz and 1 Vrms using an LCR-meter. Herein, the rate of change (%) in capacitance at each temperature was measured with respect to the capacitance at 25° C. In the present specification, the change in capacitance at 125° C. is described. When the rate of change in capacitance (temperature coefficient of capacitance, TCC) at 125° C. is within +15° C., it was determined as satisfactory, otherwise it was determined as poor.

TABLE 2

| | | | | | | | | | | Total |
|---|---|---|---|---|---|---|---|---|---|---|
| | | | | | | | | | | Content of |
| | | | | | | | | | | First and |
| | | | | | | | | | | Second |
| | Number of Moles of Minor Component per 100 | | | | | | | | | Minor |
| | Mol of Base Material Major Component | | | | | | | | | Components |
| | 1 | 2 | | 3 | 4 | 5 | | | 6 | Yb₂O₃ + |
| Sample | Yb₂O₃ | Dy₂O₃ | Y₂O₃ | BaZrO₃ | MgCO₃ | V₂O₅ | MnO₂ | Cr₂O₃ | Ba_{0.6}Ca_{0.4}SiO₃ | Dy₂O₃ |
| 1 | 0 | 1.00 | 0 | 5 | 2.50 | 0.12 | 0.11 | 0.17 | 3.55 | 1.00 |
| 2 | 0.10 | 1.00 | 0 | 5 | 2.50 | 0.12 | 0.11 | 0.17 | 3.55 | 1.10 |
| 3 | 1.22 | 1.00 | 0 | 5 | 2.50 | 0.12 | 0.11 | 0.17 | 3.55 | 2.22 |
| 4 | 1.50 | 1.00 | 0 | 5 | 2.50 | 0.12 | 0.11 | 0.17 | 3.55 | 2.50 |
| 5 | 2.00 | 1.00 | 0 | 5 | 2.50 | 0.12 | 0.11 | 0.17 | 3.55 | 3.00 |
| 6 | 2.50 | 1.00 | 0 | 5 | 2.50 | 0.12 | 0.11 | 0.17 | 3.55 | 3.50 |
| 7 | 3.00 | 1.00 | 0 | 5 | 2.50 | 0.12 | 0.11 | 0.17 | 3.55 | 4.00 |
| 8 | 3.50 | 1.00 | 0 | 5 | 2.50 | 0.12 | 0.11 | 0.17 | 3.55 | 4.50 |

TABLE 3

| | | | | | Determi- |
|---|---|---|---|---|---|
| | | | | High | nation |
| | | | Sintering | Temperature | of X7R |
| | Permit- | Dissipation | Temperature | TCC | Character- |
| Sample | tivity | Factor (DF) | (° C.) | (125° C.) | istics |
| 1 | 1900 | 0.012 | 1210 | −19.4 | X |
| 2 | 1900 | 0.011 | 1220 | −14.8 | ◯ |
| 3 | 1900 | 0.009 | 1225 | −13.0 | ◯ |
| 4 | 1800 | 0.007 | 1230 | −11.1 | ◯ |
| 5 | 1500 | 0.006 | 1230 | −9.5 | ◯ |
| 6 | 1500 | 0.007 | 1240 | −8.9 | ◯ |
| 7 | 1450 | 0.008 | 1280 | −7.75 | ◯ |
| 8 | 1400 | 0.012 | 1300 | −19.8 | X |

Table 2 represents samples in which the content of the first minor component Yb is changed while the content of the second minor component Dy is fixed at 2 mol, the content of the third minor component is fixed at 5 mol, the content of the fourth minor component Mg is fixed at 2.5 mol, the total content of the fifth minor component (V, Mn, Cr) is fixed at 0.69 mol and the content of the sixth minor component is fixed at 3.55 mol, and Table 3 represents properties of the samples corresponding to Samples 1 to 8 of Table 2.

When the content of the first minor component Yb is 0 mol (Sample 1), the high temperature TCC (125° C.) deviated from +15%, making it vulnerable to a temperature change. In addition, when the content of the first minor component Yb is greater than 6 mol (Sample 8), the high temperature TCC (125° C.) deviated from +15%, causing a problem of being vulnerable to a temperature change. On the other hand, when the content of the first minor component Yb is in a range of greater than 0 mol (for example, 0.2 mol or greater) and 6 mol or less (Samples 2 to 7), the high temperature TCC was within +15%, satisfying the X7R standard. Accordingly, it may be said that the appropriate content range of the first minor component is 0.2 parts by mole to 6 parts by mole or less with respect to 100 parts by mole of the base material major component.

Meanwhile, as the content of the first minor component Yb increases, the temperature coefficient of capacitance decreases, however, the sintering temperature tends to increase. In other words, when the content of Yb is 7 mol or greater, a sintering temperature of 1300° C. or higher is required, and when the sintering temperature becomes excessively high, a problem such as damaging the Ni internal electrode may occur. In order to address this problem, the dielectric composition according to embodiments of the present disclosure is characterized by adding all of the first to third minor components to BaTiO₃. As shown in the table, when all of the first to third minor components are included in the dielectric composition, the X7R standard may be satisfied even without increasing the content of the first minor component Yb to 7 mol or greater. Since the content of Yb, which is added to the dielectric composition to satisfy the X7R standard, is able to be reduced, it is effective in suppressing an increase in the sintering temperature.

In addition, when the total content of the first minor component and the second minor component is in a range of 2 parts by mole to 4 parts by mole (Samples 3 to 7), the dissipation factor (DF) was less than 0.01. Accordingly, when the total content of the first minor component and the second minor component is in the range of 2 parts by mole to 4 parts by mole (Samples 3 to 7), the permittivity is high with a value of 1400 or greater and the dissipation factor (DF) is less than 0.01 while satisfying the standard of X7R, and therefore, it may be said that the composition is suitable for an alternating current circuit.

TABLE 4

| | | | | | | | | | | Total |
|---|---|---|---|---|---|---|---|---|---|---|
| | | | | | | | | | | Content of |
| | | | | | | | | | | First and |
| | | | | | | | | | | Second |
| | Number of Moles of Minor Component per 100 | | | | | | | | | Minor |
| | Mol of Base Material Major Component | | | | | | | | | Components |
| | 1 | 2 | | 3 | 4 | 5 | | | 6 | Yb₂O₃ + |
| Sample | Yb₂O₃ | Dy₂O₃ | Y₂O₃ | BaZrO₃ | MgCO₃ | V₂O₅ | MnO₂ | Cr₂O₃ | Ba_{0.6}Ca_{0.4}SiO₃ | Dy₂O₃ |
| 9 | 2.00 | 0 | 0 | 5 | 2.50 | 0.12 | 0.11 | 0.17 | 3.55 | 2.00 |
| 10 | 2.00 | 0.10 | 0 | 5 | 2.50 | 0.12 | 0.11 | 0.17 | 3.55 | 2.10 |
| 11 | 2.00 | 1.22 | 0 | 5 | 2.50 | 0.12 | 0.11 | 0.17 | 3.55 | 3.22 |
| 12 | 2.00 | 1.50 | 0 | 5 | 2.50 | 0.12 | 0.11 | 0.17 | 3.55 | 3.50 |
| 13 | 2.00 | 2.00 | 0 | 5 | 2.50 | 0.12 | 0.11 | 0.17 | 3.55 | 4.00 |
| 14 | 2.00 | 2.50 | 0 | 5 | 2.50 | 0.12 | 0.11 | 0.17 | 3.55 | 4.50 |
| 15 | 2.00 | 3.00 | 0 | 5 | 2.50 | 0.12 | 0.11 | 0.17 | 3.55 | 5.00 |
| 16 | 2.00 | 3.50 | 0 | 5 | 2.50 | 0.12 | 0.11 | 0.17 | 3.55 | 5.50 |

TABLE 5

| | | | | | Determi- |
|---|---|---|---|---|---|
| | | | | High | nation |
| | | | Sintering | Temperature | of X7R |
| | Permit- | Dissipation | Temperature | TCC | Character- |
| Sample | tivity | Factor (DF) | (° C.) | (125° C.) | istics |
| 9 | 1900 | 0.009 | 1220 | −19.0 | X |
| 10 | 1900 | 0.008 | 1225 | −14.9 | ◯ |
| 11 | 1800 | 0.008 | 1235 | −9.3 | ◯ |
| 12 | 1500 | 0.008 | 1240 | −8.9 | ◯ |
| 13 | 1450 | 0.008 | 1280 | −7.6 | ◯ |
| 14 | 1450 | 0.012 | 1300 | −6.5 | ◯ |
| 15 | 1400 | 0.012 | 1310 | −6.0 | ◯ |
| 16 | 1400 | 0.013 | 1315 | −19.5 | X |

Table 4 represents samples in which the content of the second minor component Dy is changed while the content of the first minor component Yb is fixed at 4 mol, the content of the third minor component is fixed at 5 mol, the content of the fourth minor component Mg is fixed at 2.5 mol, the total content of the fifth minor component (V, Mn, Cr) is fixed at 0.69 mol and the content of the sixth minor component is fixed at 3.55 mol, and Table 5 represents properties of the samples corresponding to Samples 9 to 16 of Table 4.

When the content of the second minor component Dy is 0 mol (Sample 9), the high temperature TCC (125° C.) deviated from +15%, causing a problem of being vulnerable to a temperature change. In addition, when the content of the second minor component Dy is greater than 6 mol (Sample 16), the high temperature TCC (125° C.) also deviated from +15%, causing a problem of being vulnerable to a temperature change. On the other hand, when the content of the second minor component Dy is in a range of greater than 0 mol (for example, 0.2 mol or greater) and 6 mol or less (Samples 10 to 15), the high temperature TCC was within #15%, satisfying the X7R standard. Accordingly, it may be said that the appropriate content range of the second minor component Dy is 0.2 parts by mole to 6 parts by mole or less in an elemental ratio with respect to 100 parts by mole of the base material major component.

In addition, when the total content of the first minor component and the second minor component is in a range of 2 parts by mole to 4 parts by mole (Samples 10 to 13), the dissipation factor (DF) was less than 0.01. Accordingly, when the total content of the first minor component and the second minor component is in the range of 2 parts by mole to 4 parts by mole (Samples 10 to 13), the permittivity is high with a value of 1400 or greater and the dissipation factor (DF) is less than 0.01 while satisfying the standard of X7R, and therefore, it may be said that the composition is suitable for an alternating current circuit.

TABLE 6

| | | | | | | | | | | Total |
|---|---|---|---|---|---|---|---|---|---|---|
| | | | | | | | | | | Content of |
| | | | | | | | | | | First and |
| | | | | | | | | | | Second |
| | | | | | | | | | | Minor |
| | Number of Moles of Minor Component per 100 | | | | | | | | | Components |
| | Mol of Base Material Major Component | | | | | | | | | Yb₂O₃ + |
| | 1 | 2 | | 3 | 4 | 5 | | | 6 | Dy₂O₃ + |
| Sample | Yb₂O₃ | Dy₂O₃ | Y₂O₃ | BaZrO₃ | MgCO₃ | V₂O₅ | MnO₂ | Cr₂O₃ | Ba_{0.6}Ca_{0.4}SiO₃ | Y₂O₃ |
| 17 | 2.00 | 0 | 0.10 | 5 | 2.50 | 0.12 | 0.11 | 0.17 | 3.55 | 2.10 |
| 18 | 2.00 | 0.50 | 0.50 | 5 | 2.50 | 0.12 | 0.11 | 0.17 | 3.55 | 3.00 |
| 19 | 2.00 | 1.00 | 1.00 | 5 | 2.50 | 0.12 | 0.11 | 0.17 | 3.55 | 4.00 |
| 20 | 2.00 | 1.00 | 2.00 | 5 | 2.50 | 0.12 | 0.11 | 0.17 | 3.55 | 5.00 |
| 21 | 2.00 | 0 | 3.00 | 5 | 2.50 | 0.12 | 0.11 | 0.17 | 3.55 | 5.00 |
| 22 | 2.00 | 0 | 3.50 | 5 | 2.50 | 0.12 | 0.11 | 0.17 | 3.55 | 5.50 |

TABLE 7

| | | | | | Determi- |
|---|---|---|---|---|---|
| | | | | High | nation |
| | | | Sintering | Temperature | of X7R |
| | Permit- | Dissipation | Temperature | TCC | Character- |
| Sample | tivity | Factor (DF) | (° C.) | (125° C.) | istics |
| 17 | 1900 | 0.009 | 1220 | −14.5 | ◯ |
| 18 | 1500 | 0.006 | 1230 | −9.7 | ◯ |
| 19 | 1450 | 0.008 | 1280 | −8.5 | ◯ |
| 20 | 1400 | 0.012 | 1300 | −6.2 | ◯ |
| 21 | 1400 | 0.013 | 1315 | −6.0 | ◯ |
| 22 | 1400 | 0.013 | 1320 | −19.4 | X |

Table 6 represents samples in which the total content of the second minor component Dy and Y is changed while the content of the first minor component Yb is fixed at 4 mol, the content of the third minor component is fixed at 5 mol, the content of the fourth minor component Mg is fixed at 2.5 mol, the total content of the fifth minor component (V, Mn, Cr) is fixed at 0.69 mol and the content of the sixth minor component is fixed at 3.55 mol, and Table 7 represents properties of the samples corresponding to Samples 17 to 22 of Table 6.

When the total content of the second minor component Dy and Y is greater than 6 mol (Sample 22), the high temperature TCC (125° C.) deviated from ±15%, causing a problem of being vulnerable to a temperature change. On the other hand, when the total content of the second minor component Dy and Y is in a range of 0.2 mol or greater and 6 mol or less (Samples 17 to 21), the high temperature TCC was within ±15%, satisfying the X7R standard.

In addition, in Samples 17 and 21, Y is included in the second minor component as a substitute element of Dy, however, the high temperature TCC was within ±15%, satisfying the X7R standard. Thus, it may be seen that the X7R standard is satisfied even when the second minor component includes Y as a substitute element of Dy. However, it may be seen that the X7R standard is satisfied only when the total content of the elements included in the second minor component is in a range of 0.2 parts by mole to 6 parts by mole (Samples 17 to 21), and when the total content of the elements is greater than 6 parts by mole (Sample 22), the high temperature TCC (125° C.) deviates from ±15%.

Meanwhile, when the total content of the first minor component and the second minor component is in a range of 2 parts by mole to 4 parts by mole (Samples 17 to 19), the dissipation factor (DF) was less than 0.01. Accordingly, when the total content of the first minor component and the second minor component is in the range of 2 parts by mole to 4 parts by mole (Samples 17 to 19), the permittivity is high with a value of 1400 or greater and the dissipation factor (DF) is less than 0.01 while satisfying the standard of X7R, and therefore, it may be said that the composition is suitable for an alternating current circuit.

TABLE 8

| | | | | | | | | | | Total |
|---|---|---|---|---|---|---|---|---|---|---|
| | | | | | | | | | | Content of |
| | | | | | | | | | | First and |
| | | | | | | | | | | Second |
| | | | | | | | | | | Minor |
| | Number of Moles of Minor Component per 100 | | | | | | | | | Components |
| | Mol of Base Material Major Component | | | | | | | | | Yb₂O₃ + |
| | 1 | 2 | | 3 | 4 | 5 | | | 6 | Dy₂O₃ + |
| Sample | Yb₂O₃ | Dy₂O₃ | Y₂O₃ | BaZrO₃ | MgCO₃ | V₂O₅ | MnO₂ | Cr₂O₃ | Ba_{0.6}Ca_{0.4}SiO₃ | Y₂O₃ |
| 23 | 2.00 | 1.00 | 0.50 | 3 | 2.50 | 0.12 | 0.11 | 0.17 | 3.55 | 3.50 |
| 24 | 2.00 | 1.00 | 0.50 | 5 | 2.50 | 0.12 | 0.11 | 0.17 | 3.55 | 3.50 |
| 25 | 2.00 | 1.00 | 0.50 | 7.5 | 2.50 | 0.12 | 0.11 | 0.17 | 3.55 | 3.50 |
| 26 | 2.00 | 1.00 | 0.50 | 10 | 2.50 | 0.12 | 0.11 | 0.17 | 3.55 | 3.50 |
| 27 | 2.00 | 1.00 | 0.50 | 13 | 2.50 | 0.12 | 0.11 | 0.17 | 3.55 | 3.50 |
| 28 | 2.00 | 1.00 | 0.50 | 17 | 2.50 | 0.12 | 0.11 | 0.17 | 3.55 | 3.50 |
| 29 | 2.00 | 1.00 | 0.50 | 25 | 2.50 | 0.12 | 0.11 | 0.17 | 3.55 | 3.50 |
| 30 | 2.00 | 1.00 | 0.50 | 30 | 2.50 | 0.12 | 0.11 | 0.17 | 3.55 | 3.50 |

TABLE 9

| | | | | Determi- |
|---|---|---|---|---|
| | | | High | nation |
| | | | Temperature | of X7R |
| | Permit- | Dissipation | TCC | Character- |
| Sample | tivity | Factor (DF) | (125° C.) | istics |
| 23 | 1700 | 0.012 | −2.96 | ◯ |
| 24 | 1500 | 0.006 | −9.50 | ◯ |
| 25 | 1500 | 0.012 | −16.10 | X |
| 26 | 1450 | 0.015 | −24.31 | X |
| 27 | 1450 | 0.018 | −43.20 | X |
| 28 | 1400 | 0.020 | −62.10 | X |
| 29 | 1400 | 0.025 | −58.41 | X |
| 30 | 1400 | 0.027 | −53.76 | X |

Table 8 represents samples in which the content of the third minor component is changed while the content of the first minor component Yb is fixed at 4 mol, the total content of the second minor component (Dy, Y) is fixed at 3 mol, the content of the fourth minor component Mg is fixed at 2.5 mol, the total content of the fifth minor component (V, Mn, Cr) is fixed at 0.69 mol and the content of the sixth minor component is fixed at 3.55 mol, and Table 9 represents properties of the samples corresponding to Samples 23 to 30 of Table 8.

When the content of the third minor component is greater than 6 mol (Samples 25 to 30), the high temperature TCC (125° C.) deviated from +15%, causing a problem of being vulnerable to a temperature change. On the other hand, when the content of the third minor component is in a range of 6 mol or less (Samples 23 and 24), the high temperature TCC was within +15%, satisfying the X7R standard. In addition, when the content of the third minor component is less than 4 mol (Sample 23), the dissipation factor (DF) was greater than 0.01, but when the content of the third minor component is 4 mol or greater (Sample 24), the dissipation factor (DF) was less than 0.01. Accordingly, when the content of the third minor component is in the range of 4 parts by mole to 6 parts by mole with respect to 100 parts by mole of the base material major component (Sample 24), the permittivity is high with a value of 1400 or greater and the dissipation factor (DF) is less than 0.01 while satisfying the standard of X7R, and therefore, it may be said that the composition is suitable for an alternating current circuit.

The present disclosure is not limited by the above-described embodiments and accompanying drawings, but is limited by the appended claims. Accordingly, it will be obvious to those skilled in the art that various forms of substitutions, modifications and changes are possible within the scope that does not depart from the technical ideas of the present disclosure described in the claims, and these also fall within the technical ideas described in the appended claims.

1. A dielectric composition comprising:
a barium titanate-based base material major component; and
a minor component,
wherein the minor component includes at least one minor component among a first minor component including one or more selected from the group consisting of oxides and carbonates of one or more elements among Yb, Sc, Lu and Tm; a second minor component including one or more selected from the group consisting of oxides and carbonates of one or more elements among Dy, Y, Ho, Tb, Gd, Eu and Er; a third minor component including one or more selected from the group consisting of oxides including Ba and Zr; a fourth minor component including one or more of oxides and carbonates of fixed-valence acceptor element including Mg; a fifth minor component including one or more selected from the group consisting of oxides and carbonates of variable-valence acceptor element including one or more of V, Mn, Cr, Fe, Ni, Co, Cu, and Zn; and a sixth minor component including one or more selected from the group consisting of oxides, carbonates and glass of Si element;
the at least one minor component includes the first minor component, the second minor component and the third minor component;
a content of the one or more elements included in the first minor component is 0.2 parts by mole to 6 parts by mole with respect to 100 parts by mole of the base material major component;
a content of the one or more elements included in the second minor component is 0.2 parts by mole to 6 parts by mole with respect to 100 parts by mole of the base material major component; and
a content of the third minor component is 4 parts by mole to 6 parts by mole with respect to 100 parts by mole of the base material major component.

2. The dielectric composition of claim 1, wherein the first minor component includes a Yb element.

3. The dielectric composition of claim 1, wherein a total content of the first minor component and second minor component is 2 parts by mole to 4 parts by mole.

4. The dielectric composition of claim 1, wherein the second minor component includes Dy₂O₃ and Y₂O₃, and a total content of Dy and Y included in the second minor component is 0.2 parts by mole to 6 parts by mole.

5. The dielectric composition of claim 1, wherein the at least one minor component further includes the fourth minor component, and a content of the Mg element included in the fourth minor component is 0.1 parts by mole to 3 parts by mole with respect to 100 parts by mole of the base material major component.

6. The dielectric composition of claim 1, wherein the at least one minor component further includes the fifth minor component, and a content of the variable-valence acceptor element included in the fifth minor component is 0.03 parts by mole to 4 parts by mole with respect to 100 parts by mole of the base material major component.

7. The dielectric composition of claim 1, wherein the at least one minor component further includes the sixth minor component, and a content of the sixth minor component is 0.1 parts by mole to 5 parts by mole with respect to 100 parts by mole of the base material major component.

8. The dielectric composition of claim 7, wherein the sixth minor component includes a composite oxide represented by BaₓCa₁₋ₓSiO₃ (herein, x is 0.3 to 0.8).

9. A method for preparing a dielectric composition, the method comprising:
preparing a barium titanate-based base material major component;
preparing at least one minor component including, among a first minor component including one or more selected from the group consisting of oxides and carbonates of one or more elements among Yb, Sc, Lu and Tm; a second minor component including one or more selected from the group consisting of oxides and carbonates of one or more elements among Dy, Y, Ho, Tb, Gd, Eu and Er; a third minor component including one or more selected from the group consisting of oxides including Ba and Zr; a fourth minor component including one or more of oxides and carbonates of fixed-valence acceptor element including Mg; a fifth minor component including one or more selected from the group consisting of oxides and carbonates of variable-valence acceptor element including one or more of V, Mn, Cr, Fe, Ni, Co, Cu, and Zn; and a sixth minor component including one or more selected from the group consisting of oxides, carbonates and glass of Si element, the first minor component, the second minor component and the third minor component;
preparing a mixture including the base material major component and the at least one minor component; and
calcining the mixture,
wherein a content of the one or more elements included in the first minor component is 0.2 parts by mole to 6 parts by mole with respect to 100 parts by mole of the base material major component;
a content of the one or more elements included in the second minor component is 0.2 parts by mole to 6 parts by mole with respect to 100 parts by mole of the base material major component; and
a content of the third minor component is 4 parts by mole to 6 parts by mole with respect to 100 parts by mole of the base material major component.

10. The method of claim 9, wherein a sintering temperature of the mixture is 1210° C. or higher.
